(19) United States
(12) Patent Application Publication
(10) Pub. No.: US 2003/0044711 A1
(43) Pub. Date: Mar. 6, 2003

(54) Irregular shaped ferrite carrier for conductive magnetic brush development

(75) Inventor: William R. Hutcheson, Valparaiso, IN (US)

Correspondence Address: BANNER & WITCOFF, LTD., TEN SOUTH WACKER DRIVE, SUITE 3000, CHICAGO, IL, 60606, US

(73) Assignee: Powdertech International Corp., Valparaiso, IN

(21) Appl. No.: 10/225,964

(22) Filed: Aug. 22, 2002

Related U.S. Application Data
(60) Provisional application No. 60/314,844, filed on Aug. 24, 2001.

(51) Int. Cl. G03G 9/107

(52) U.S. Cl. 430/111.31; 430/111.41

(57) ABSTRACT

A ferrite carrier for electrophotographic developers which comprises ferrite particles with irregular, non-spherical configuration capable of forming a conductive magnetic chain, said carrier having the general formula

(MeO)ₓ(Fe₂0₃)₁₀₀ₓ

wherein MeO represents an environmentally benign metal oxide and x is less than 50 mole percent.

### CROSS REFERENCE TO RELATED APPLICATION

This is a utility application based upon provisional application Serial No. 60/314,844 filed Aug. 24, 2001 for which priority is claimed and which is incorporated herein by reference.

### BACKGROUND OF THE INVENTION

1. Field of the Invention

This invention relates to a non-spherical shaped magnetic ferrite carrier powder used for magnetic brush development in copy machines, printers and the like.

2. Background

Two component developers, which are used in magnetic brush development, consist of (1) carrier particles or beads, and (2) toner particles. The electrical properties of the carrier particles have a direct influence on the development characteristics of the system. Some reprographic systems use an insulative magnetic brush and others use a conductive magnetic brush for transport and development or placement of toner onto a substrate.

Typically spherical carrier particles of coated metal shot or ferrite are used in insulative magnetic brush systems. Conventionally ferrite carrier powders are composed of spherical beads, and thus their utility is associated with insulative magnetic brush systems (see for instance, U.S. Pat. Nos. 3,839,029 or 3,914,181 or 3,929,657).

In contrast, irregular shaped metal powders are useful in conductive magnetic brush development systems (see for instance, U.S. Pat. No. 4,076,857). That is, conductive magnetic brush development utilizes irregular shaped particles since point contact between irregular particles allows higher and more effective conductivity paths along carrier bead or particle chains. Because of their irregular bead shapes and their conductive properties metal powders are used as carrier particles or beads for conductive systems. However, metal powders have certain characteristics or electrical properties that cannot be changed as easily as those of ferrite compositions. Also the density of metal (weight per unit of volume) is greater than that of ferrite carriers and thus may result in accelerated wear of copy machine components. Further, the magnetic and surface characteristics of ferrites can be changed easily while these properties of metal powders are substantially fixed.

### SUMMARY OF THE INVENTION

The present invention comprises a magnetic ferrite carrier having irregular shaped particles that allow point contact of the carrier beads or particles resulting in higher conductivity paths down bead chains. The particles are therefore useful in conductive magnetic brush development applications such as those in which non-spherical metal particles have been used. The composition of the ferrite carrier of the invention is represented by the formula;

(MeO)ₓ (Fe₂O₃)₁₀₀₋ₓ

where “MeO” is any divalent ferrite forming metal oxide or combinations of two or more divalent metal oxides, and “x” is less than 50 mole percent. Typical ferrite forming divalent metal oxides are FeO, MnO, NiO, CuO, ZnO, CoO, MgO, CaO, and Li_{0.5}Fe₃+_{0.5}O. Ferrites of this type are known as surplus iron containing ferrite compositions. Some applications require that only environmentally benign metal oxides be present in the composition and therefore comprise surplus iron containing ferrite compositions having metal elements that meet specific environmental regulations such as Fe, Ca, Mg, Li and Mn.

The conductivity of the disclosed ferrite particles may vary based on the composition and the sintering protocol. Since the ferrite compositions are considered to be surplus iron ferrites, the oxygen content of the sintering atmosphere determines the amount of divalent Fe⁺⁺ in the structure and therefore provides a means to control the magnetic and conductive properties of the material.

Thus it is an object of the invention to provide a magnetic ferrite carrier in the form of particles having an irregular shape.

It is a further object of the invention to provide such carrier particles having lower density than metal carriers and having the capability of creating desired magnetic and conductive properties.

These and other objects, advantages and features of the invention are set forth in the detailed description which follows.

### BRIEF DESCRIPTION OF THE DRAWING

In the detailed description which follows, reference will be made to the drawing comprised of the following figures:

FIG. 1 is a microphotograph is a spherical magnetite carrier case, i.e. magnetite;

FIG. 2 is a microphotograph of irregular carrier particles of ferrite material comprising an example of the invention; and

FIG. 3 is a diagrammatic view of the conductive properties of spherical and irregular carrier particles.

### DESCRIPTION OF THE PREFERRED EMBODIMENT

To prepare the irregular shaped, ferrite carrier particles of the invention, the following protocol is utilized. First, one or any number of combinations of divalent metal oxides along with iron oxide in the amounts described by the formula (MeO)ₓ (Fe₂O₃)_{100-x,} where X is less than 50 mole percent, are mixed intensely. Dry or wet mixing is acceptable. An attritor or ball type, grinding mill is preferred to effect mixing. The ideal size of particles after grinding/mixing is one micron or less, though larger average particle sizes do produce acceptable results. With wet mixing, organic binders and dispersants dissolved in water are used. If wet mixing is used, the slurry must be dried. Conventional spray drying is one way in which this may be accomplished, though other granule producing drying processes are suitable. If dry mixing is used, of course, further drying is not required.

The powder containing the intensely mixed oxides is then mixed with water in a pelletizing or granulation device. The pellets or granules produced by this operation ideally range in size from 1 mm to 10 mm in diameter, though larger or smaller granules are permissible.

Subsequently, the pellets or granules must be calcined to form a partial spinel structure associated with the desired ferrite composition. Typical calcine temperatures range from 500° C. to 1200° C. depending on the particular type of ferrite and desired particle properties. Soak times typically are 15 minutes to 2 hours, though longer or shorter times are permissible. This calcining may be accomplished in any furnace type unit capable of reaching those temperatures described.

The calcination step effects reaction of the divalent metal oxides with iron oxide to a degree which forms a solid phase that is not completely sintered, yet allows handling without high levels of airborne dust or degradation. When metals such as manganese are used a higher temperature range of (900-1200)° C. is preferred while metals such as zinc may be calcined at a lower temperature range of (500-900))° C. Carbon black can be added at the calcine step as a reducing agent, which will be liberated during the sintering phase. It should be noted that the lower temperature processed metals are generally considered to be environmentally undesirable. Conversely, the higher temperature processed metals are considered to be more environmentally acceptable.

The calcined ferrite pellets or granules are then shattered by means of mechanical impact milling or crushing. This step produces irregular shapes as well as reduces particle size. The material which has been processed as described must then be classified. Classification can be achieved by screening, which removes coarse and fine particles. The mesh sizes used in screening are selected based on final product particle size requirements.

Calcined irregular shaped particles which have been size classified based on final application requirements are subsequently sintered in a kiln or furnace which is capable of reaching temperatures of 1000° C. to 1400° C. depending on the sintering requirements of each particular ferrite composition. Typical optimal sizes of particles are in the range of 70-80 microns whereas particles sized in the range of 30-120 microns may be desired.

Atmosphere control is necessary during the sintering and cooling cycle to adjust the magnetic and electrical properties similar to spherical ferrite carriers (see for instance, U.S. Pat. No. 4,485,162, incorporated by reference). The process of sintering in low oxygen atmosphere to obtain high magnetic moment and low volume resistivity on ferrite particles is understood by those of ordinary skill in the art of sintering ferrite. Typically the level of oxygen control in the sintering and cooling atmosphere will determine the amount of FeO and Fe₃O₄ formed from the surplus iron within the ferrite compositon and accordingly resistivity may be adjusted and controlled in this manner. Increased amounts of FeO will result in relatively increased conductivity and vice versa. Further, coating of the particles will typically reduce conductivity which may be a desirable result or combination in some instances for some applications.

Sintered powder, which is processed as described is deagglomerated by a hammer type mill. This finely divided powder is then classified with standard type screening units. The screen mesh size is selected based on the final magnetic brush requirements which may vary for each machine application. Since each of these particles are irregular and have varying aspect ratios, it may be necessary to use rectangular mesh or other configuration mesh screens for final classification. Air classification can also be used as necessary to remove the fine particles tailing where necessary. The optimum particle size distribution will be determined by the individual application where consideration will be taken for toner loading, brush height, photoconductor scratching and so forth.

Following are examples of the invention:

### EXAMPLE 1

The example in Table 1 describes the characteristics of a typical copper zinc ferrite body made into both a spherical and an irregular version. The process for manufacture of the irregular version is set forth above.

TABLE 1

| | Comparative | Present |
|---|---|---|
| | Sample | Invention |
| Copper Zinc Ferrite | Spherical Carrier | Irregular Carrier |
| Fe₂0₃ Mole % | 69.0% | 69.0 |
| CuO Mole % | 15.5 | 15.5 |
| ZnO Mole % | 15.5 | 15.5 |
| Avg. Size (microns) | 50 | 50 |
| Ms (emu/g) | 71.4 | 70.4 |
| Apparent Density (g/cc) | 2.51 | 2.48 |
| BET Surface Area (cm₂/g) | 345 | 478 |
| Dynamic Resistivity | | |
| 5% Toner @ 100 V (ohms-cm) | 1.8 × 10⁹ | 6.3 × 10⁷ |

From the results shown in Table 1, the irregular shape alone produces a lower dynamic resistivity when used in magnetic brush development application. The present invention makes it possible to substitute an irregular ferrite carrier in an application which has until now required an oxidized or coated metal carrier.

### EXAMPLE 2

TABLE 2

| | Comparative | Present |
|---|---|---|
| | Sample | Invention |
| Zinc Ferrite | Spherical Carrier | Irregular Carrier |
| Fe₂0₃ Mole % | 80 | 80 |
| MnO Mole % | 20 | 20 |
| Avg. Size (microns) | 90 | 90 |
| Ms (emu/g) | 93.5 | 93.5 |
| Bulk Density (g/cc) | 2.71 | 2.26 |

Static Resistivity Measured at 1 mm gap

| | Comparative Sample | Present Invention |
|---|---|---|
| | Spherical Carrier | Irregular Carrier |
| 25 Volts | 6.1 × 10⁷ (ohms-cm) | 6.6 × 10⁵ (ohms-cm) |
| 50 Volts | 2.1 × 10⁷ (ohms-cm) | 3.2 × 10⁵ (ohms-cm) |
| 100 Volts | 2.6 × 10⁶ (ohms-cm) | 4.7 × 10⁴ (ohms-cm) |
| 200 Volts | 1.7 × 10⁶ (ohms-cm) | Breakdown |
| 300 Volts | 9.7 × 10⁵ (ohms-cm) | |

The results in Table 2 show that lower static resistivity is measured on an irregular carrier than the same carrier material made in a spherical shape.

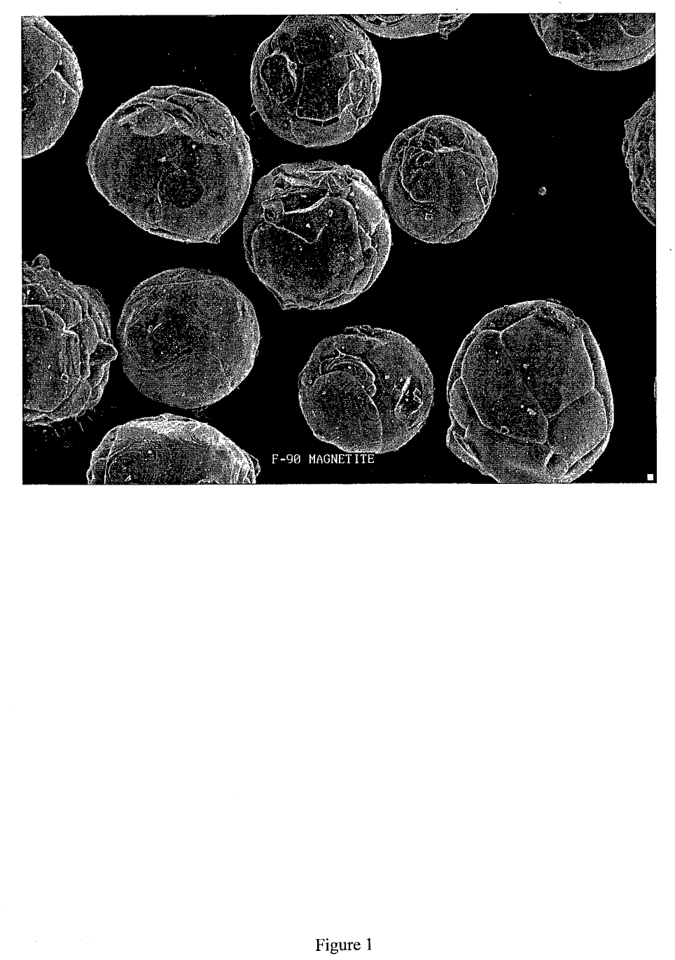

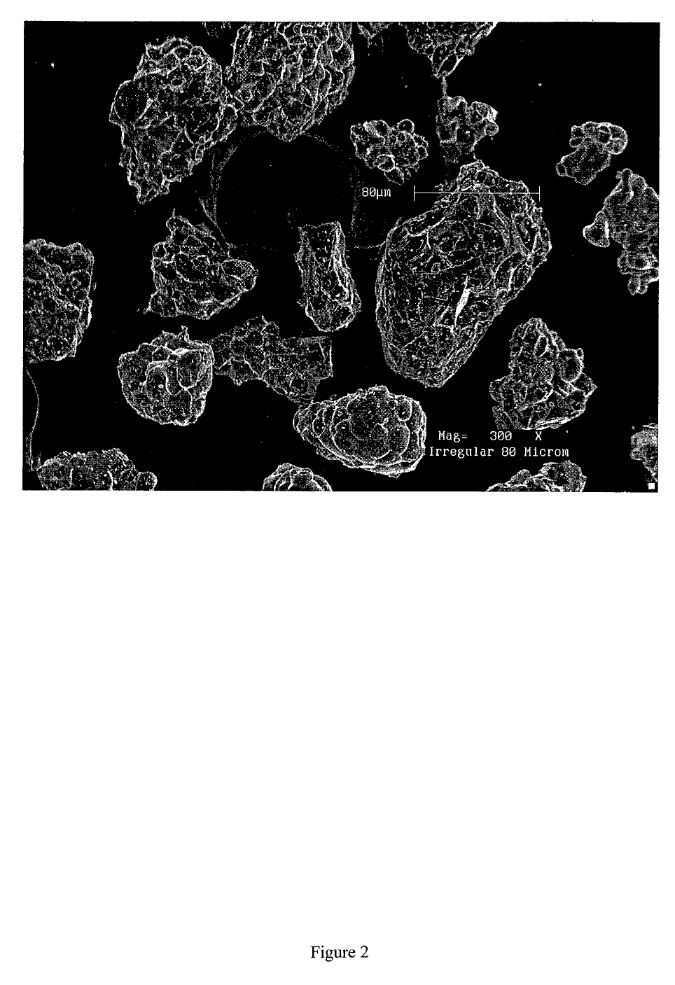

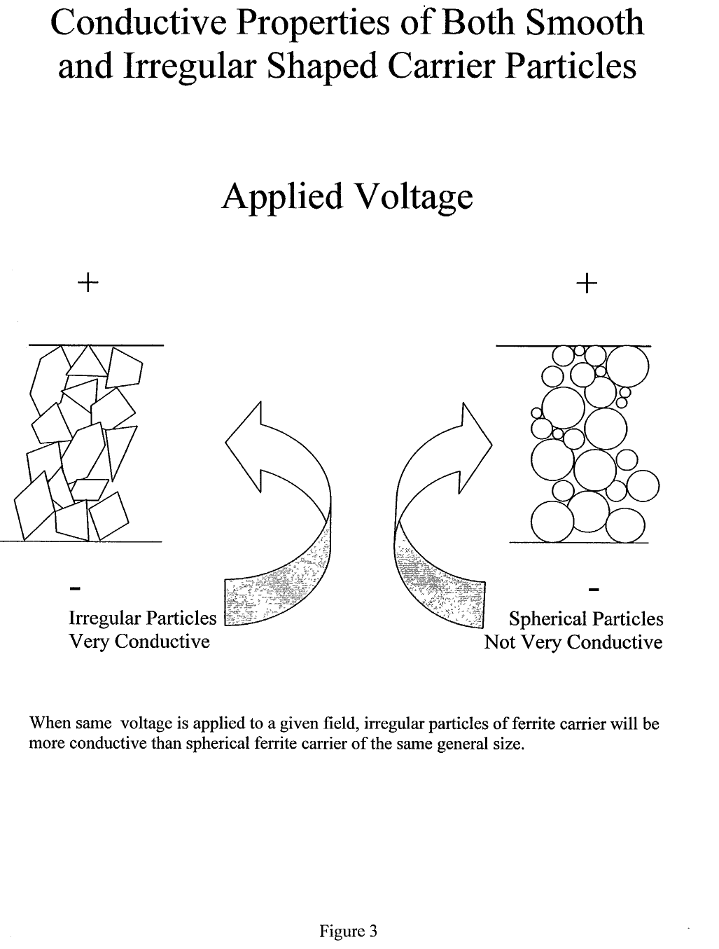

Referring to the Figures, FIG. 1 illustrates a typical prior art spherical carrier core particles formed of magnetite. FIG. 2 depicts irregular ferrite carrier core particles made in accord with the process that is set forth above. FIG. 3 illustrates the conductive properties of spherical and irregular shaped carrier particles. It will be noted that irregular shapes allow sharp point contact, whereas a smooth, i.e. spherical, shape does not necessarily provide a sharp point contact. Additionally if any of the particles are various sized, then there is the potential, with spherical particles, to develop gaps.

Variations may be imposed with respect to the compositional characteristics of the ferrite materials while still enabling practice of the invention. Importantly, the methodology or method of fabrication of the ferrite particle to insure the irregular shape in combination with the constituents for the formation of the particles comprises an important aspect of the invention. The compositional aspects were set forth above and the utilization of divalent ferrite forming materials is important in the practice of the invention. The invention may therefore be altered without changing the scope thereof. The invention should be limited only by the following claims and equivalents thereof.

What is claimed is:

1. A non-spherical, irregular shaped magnetic carrier particle comprising in combination a ferrite having a composition represented by the formula:
(MeO)ₓ(Fe₂0₃)₁₀₀₋ₓ
wherein “MeO” is selected from the group consisting of a divalent ferrite forming metal oxide and combinations of two or more divalent ferrite forming metal oxides, and “X” is less than 50 mole percent characterized by a non-spherical shape of the powder particles.

2. The particle of claim 1 wherein the metal oxides are selected from the group comprising oxides of iron, manganese, nickel, copper, magnesium, calcium, and lithium and lithium ferrite.

3. The particle of claim 1 wherein said ferrite materials are selected from the group comprising surplus iron containing ferrite compositions.

4. The particle of claim 1 wherein said metal oxide is selected from the group consisting of iron, calcium, magnesium, lithium and manganese.

5. The particle of claim 1 in combination with like particles to form a connective electrical path between particles.

6. The particle of claim 1 wherein the non-spherical shape of the carrier provides lower resistivity under dynamic conditions than a conventional spherical shaped ferrite carrier.

7. The particle of claim 1 in combination with toner.

8. The particle of claim 1 wherein the range of magnetic moment is between 35 emu/g and 95 emu/g measured in a field of 5,000 oersteds.
